(19) United States
(12) Patent Application Publication
(10) Pub. No.: US 2012/0060515 A1
(43) Pub. Date: Mar. 15, 2012

(54) INSULATION, IN AN ARGON ATMOSPHERE, OF A DOUBLE-WALLED LIQUEFIED GAS TANK

(75) Inventor: Damien Feger, Vernon (FR)

(73) Assignee: NEW GENERATION NATURAL GAS, Paris (FR)

(21) Appl. No.: 13/264,099

(22) PCT Filed: Apr. 9, 2010
(86) PCT No.: PCT/FR2010/050692

§ 371 Date: Nov. 16, 2011

(30) Foreign Application Priority Data
Apr. 15, 2009 (FR) 0901829

(51) Int. Cl. F17C 3/08

(52) U.S. Cl. 62/45.1

(57) ABSTRACT

A double-walled liquefied gas tank characterized in that one or more insulation spaces about the vat containing the liquid are filled with a mixture, consisting mainly of argon trapped by gravity, between the outer walls of the vat and: a) for the insulating space (2) located below the bottom wall of the vat, the base plate (3) supporting the vat; b) for the insulating spaces (5) and (6), the circular chamber (16); c) for the insulation spaces (7) and (25), the circular chamber (16) and the roof (17); d) for the insulation space (14), the suspended and sealed ceiling (12), respectively.

### 1. TECHNICAL FIELD OF THE INVENTION

The invention relates to low-temperature liquefied gas storage tanks, in particular tanks intended for receiving Liquefied Natural Gas (LNG) or liquid oxygen . . . . It applies in particular to large-capacity tanks (several thousand m³), used in the liquefaction plants for said gases, or the LNG reception terminals.

### 2. BACKGROUND OF THE INVENTION

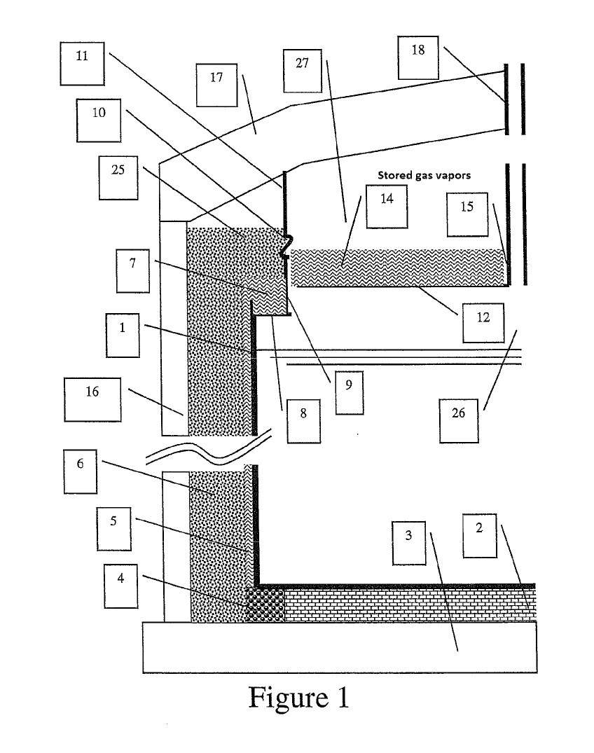

FIG. 1 shows a cross-sectional view illustrating the main characteristics of the tanks currently used to store said liquefied gases. These tanks are generally cylindrical and include the following elements:

A cylindrical tub made from cryogenic steel (1) whereof the bottom rests, via an insulating layer (2) (generally made up of slabs of glass foam, expanded foam, or plywood boxes filled with powdery or fibrous plywood), on a base, typically made from concrete (3), and the vertical walls of which rest on a crown of insulating concrete (4). The vertical walls of the tub are surrounded by thermal insulation made up of a foamed glass bead powder (6) and a layer of rock wool or glass (5).

The function of this resilient layer of fibrous insulating wool is to absorb the expansion and contraction movements of the tub and thereby prevent cavities from forming in the foamed glass bead volume and degrading the heat performance.

Both to react the mechanical forces and to prevent, in case of earthquake, a wave of liquefied natural gas from passing above the wall of the tub, a circular ring (8) is generally placed at the apex thereof. Said ring is also insulated by a volume of rock or glass wool (7), above which there is an additional volume (25) of foamed glass beads that, filled during the construction, serves to offset any compression of said material and thereby to prevent an insulation flaw.

To prevent the foamed glass beads from escaping and falling into the tub, different barriers, generally metallic (9) and (11), are put into place, as well as one or more flexible seals (10), porous to the gas and generally made from fiberglass.

To ensure the confinement, relative to the outside, of the vapors escaping the stored liquefied gas, the tub is surrounded by a circular enclosure (16) and a roof (17), generally made from concrete that is gas-tight and thus forms a barrier that can contain the liquid contained in the tub. The wall (16) and the base (3) also sometimes play the role of a second seal to the liquefied gas making it possible to contain said gas in the event of a leak of the tub (1). The roof (17) of the tank is insulated by a suspended ceiling (12) that supports a thickness of insulation (14), generally made from rock or glass wool.

The tub is equipped with different equipment and pumps ensuring filling, emptying, pressure control and monitoring, for which we have shown, in a simplified manner, only the pipe (15) and the sealed roof crosspiece (18) for vapors escaping the liquid.

For safety reasons (preventing a leak of outside air toward the inside creating a potentially explosive mixture) and to limit the pressure forces on the walls, the liquefied gas contained in the tub is kept at a pressure generally slightly higher than the atmospheric pressure, and is continuously boiling, under the effect of the various thermal inputs. To avoid a pressure increase, the gas vapors are discharged via the pipe (15) and the crosspiece (18) toward the outside.

This continuous evaporation of the stored gas is, of course, a loss for the operator and the evaporation rate of the tank must be reduced as much as possible, typically by about 0.015% per day.

It will be noted that to avoid any force related to pressure differences:
the volume (26) of vapor above the tub containing the liquefied gas (1);
the volume (27) situated between the suspended ceiling (12) and the roof (17);
the annular volumes (5), (6), (7) and (25) between the vertical walls of the tub (1) and the concrete vertical wall (16); and
the volume (2) between the bottom of the tub (1) and the base (3)
   are all in communication with each other and are filled with vapors of the gas contained in the tub (1).

If, for the crown (4), the thermal inputs are essentially related to the solid conductivity of the materials used, it will be noted that, on the bottom, sides and top of the tub, these thermal inputs will also depend substantially on the thermal conductivity of said vapors, the insulating materials occupying these volumes serving to prevent radiating and convective exchanges in these insulating volumes.

The subject matter of the present invention is to replace the gas vapors present in these volumes with a gas having a substantially lower thermal conductivity, argon, in order to significantly improve the thermal performance of the tank and reduce its evaporation rate.

### 3. BRIEF DESCRIPTION OF THE INVENTION

The table below provides the thermal conductivities of the argon vapors compared to those of the vapors of nitrogen, oxygen, and methane.

| | Conductivity of | Conductivity of | Conductivity of |
|---|---|---|---|
| Temperature | the argon | the oxygen | the methane |
| (° C.) | (mW/mK) | (mW/mK) | (mW/mK) |
| −163 | 7.3 | 10.4 | Liquide |
| −123 | 9.7 | 14.1 | 16.3 |
| −73 | 12.5 | 18.5 | 21.9 |
| 27 | 17.6 | 26.2 | 34.1 |

It can be seen that, in all cases, argon vapors have a heat conductivity several tens of percentage points lower than those of the other gases.

Therefore, by replacing these vapors in the different insulation spaces of the tank, it is possible to significantly reduce (typically by approximately ten percent) the thermal inputs into the tub (1).

Furthermore, looking at the table below, it will be noted that:
argon has a higher molar mass, and therefore a higher density, than the other gases; it will, however, be noted that under equal temperature and pressure conditions, argon vapors are heavier than oxygen and methane vapors;
its boiling temperature is lower than that of the other gases; it will therefore be noted that argon will remain in vapor state, even in direct thermal contact with the liquefied gases contained in the tub.

| Gas | Argon | Oxygen | Methane |
|---|---|---|---|
| Atomic mass (g) | 39.9 | 32.0 | 16 |
| Boiling temper- | −185 | −182 | −161 |
| ature (° C.) | | | |

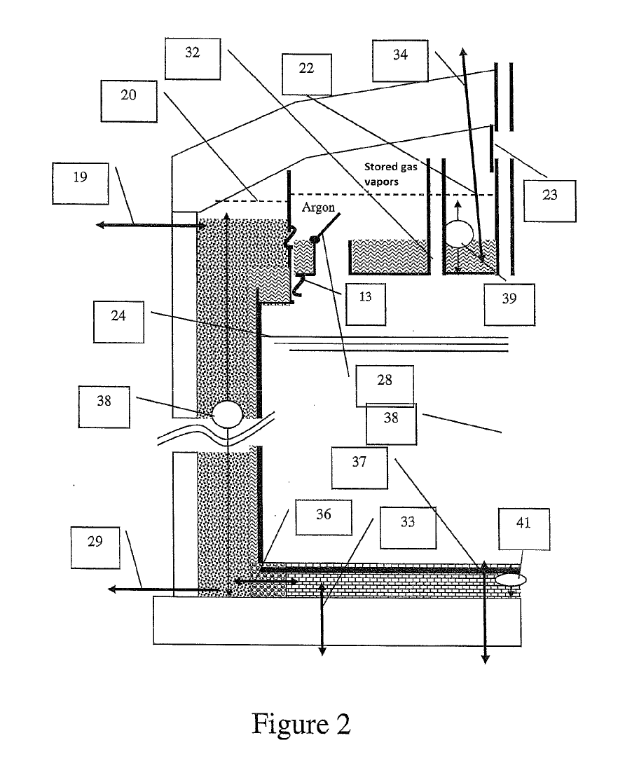

FIG. 2 illustrates how these two properties can be used to improve the state of the art of these tanks.

The general configuration of the tank remains unchanged. It is only necessary to install injection points for injecting argon into the insulation spaces:
via one or more pipes (19), through the wall (16), to fill the insulation spaces (5), (6) and (25) with argon;
via one or more pipes (33), through the base (3), to fill the insulation space (2) with argon;
via one or more pipes (34), through the roof (17), to fill the insulation space (14) with argon.

In the volumes (5), (6) and (25), the oxygen or methane vapors will therefore be displaced, by gravity, upward by the argon vapors and pushed toward the gaseous dome of the tank (27). Due to the injection of argon via the pipe (19), the volumes (5), (6) and (25) will therefore gradually be filled with argon, until the levels of argon reach the top of the space (25). It will be noted that any excess argon will also spill into the dome (27), which prevents any risk of creating an overpressure of these different insulating volumes.

In the volume (2), the methane or oxygen vapors initially present may also be replaced with argon by discharging them via one or more pipes (37) passing through the base (3) and emerging in the top of the volume (2). Said pipe (37) will also be used to discharge any excess argon and to thereby avoid an overpressure if the volume (2) is not also connected to the volume (5) via one or more pipes (36) through the insulating concrete crown (4).

The quantities of argon injected into these volumes (5), (6), (25) and (2) will therefore remain naturally trapped, by gravity, without it being necessary to supply those volumes continuously to keep them under argon, which drastically limits the duration and complexity, and therefore the costs, of the corresponding operations.

On the other hand, if no precautions are taken, the argon injected into the gaseous dome (27) above the suspended ceiling (12), to replace the oxygen or methane vapors initially present in the insulating space (14) with that gas, will flow, by gravity, into the tub containing the liquefied gas, where it will either be dissolved in the mass of stored liquid gas or will escape via the pipe (18) and will therefore be lost without meeting the objective of filling the insulating volume (14) with argon.

To avoid this, and trap the argon in said volume (14), by gravity, a sealing barrier to the argon gas must be put into place for the argon present not to be able to escape toward the volume (26), while making it possible to:
balance the pressures between the volumes (26) and (27);
keep the possibility of discharging excess vapors escaping from the liquefied gas stored in the tub (1) present in the gaseous dome of the tank, below (26) and above (27) the suspended ceiling (12).

To that end, a tank designed according to the innovation will have the following features:
the suspended ceiling (12) will be designed to be sealed against argon vapors;
a flexible membrane (13) designed to be sealed against argon vapors while allowing mechanical decoupling of the ceiling (12) from the ring 8 or the barrier (9) will be installed on the perimeter of the ceiling (12).

These seals, for small pressure deviations (a priori related to the different hydrostatic pressures between the argon and the vapors of the stored gas) may be done easily, for example:
for the suspended ceiling (12), by adhering an aluminum film between the different panels making it up and ensuring that the fastening points of the rigging lines supporting said ceiling do not pass through those panels;
for the flexible membrane (13), by also using a fabric including an aluminum film.

The same procedure may be used for the connections between the wall (1), the ring 8 and the barrier (9) to prevent the argon contained in the volumes (7) and (25) from flowing into the tub (1).

These techniques may also be used to seal the different cross-pieces (15) of the suspended ceiling (12), like those ensuring the passage of filling and emptying hoses for the tub, not shown in the figures for clarity reasons.

If no precautions are taken, these seals will no longer make it possible to ensure equal pressures between the volumes (26) and (27). It is therefore necessary to provide one or more pipes (32) ensuring free communication between those two volumes, but they must also be gas-tight and emerge at a sufficient height above the ceiling level (12) to prevent the retained argon from flowing, by gravity, toward the volume (26). These pipes may advantageously for example be made around hoses serving to fill or empty the tub.

It is advantageously possible to install a baffle (23), or an equivalent system, between the end of the pipe (15) and the crosspiece (18) and to have the end of the pipe (15) emerge as high as possible to prevent the vapors coming from the tub from driving the argon vapors contained in the volume (27) above the ceiling (12).

If these precautions are taken, one can see that, as illustrated in FIG. 2), the argon injected into the volumes (2), (5), (6), (7), (25), (14) and (27) will remain trapped there by gravity.

It will be noted that the volumes (25) and (27) will be only partially filled with argon, the boards (20) and (22) between the argon vapors and those of the gas contained in the tub (1) being displaced not only on the basis of the quantities of argon injected, but also as a function of the evolution of the temperature and pressure in the insulating volumes.

It will be noted that, using these different means, the pressures are perfectly controlled between the different volumes:
the vapors escaping from the stored gas can escape toward the outside via the pipes (15) and (18);
if the quantity of argon present in the different insulating volumes is not sufficient to fill them, a vacuum is avoided because said volumes can be supplied via the baffle (23) by the vapors coming from the gas stored in the tub;
if the quantity of argon present in the different insulating volumes is excessive, an overpressure is avoided because this excess argon can be discharged, via the baffle (23) toward the outside.

During exploitation operations of the tank (filling, emptying, etc.), the temperature and pressure in the different insulating volumes will evolve, and therefore, if one considers that the quantity of argon present in the insulating spaces is kept constant, the variations in the volume of the argon vapors will be offset automatically by the displacement of the borders (20) and (22) between these vapors and those of the gas stored in the tub:
the low level, which will correspond to the case of a tank full of liquid, for which the temperature of the insulating spaces is lowest, at minimum, will be located just above that of the insulation (14) of the suspended ceiling, so the thermal inputs in the liquid gas are minimal;
the high level, which will correspond to the case of a tank at the end of emptying, or empty, for which the temperature of the insulating spaces is highest, and ideally, will, regarding the volume (27), be at most situated just below the baffle (23) to prevent argon losses by outward driving in the pipe (18).

Alternatively, or combined with this “passive” solution, one may adjust the quantity of argon in the insulating volumes via the pipes (19), (29), (33), (34), (35), (37) by connecting it with a connected storage or supply device for that gas (for example, using a pressurized capacity and a compressor making it possible to store or supply argon, or a buffer capacity, not shown in the figures).

This system for managing quantities of argon present in the insulation volumes may advantageously be done by sampling and analysis of the gases present at different locations or, as illustrated in FIG. 2), by differential pressure sensors (39), (40) and (41), which will measure the hydrostatic pressure difference between two gas columns:
one filled with the gas present in these different volumes;
the other filled with vapors of the stored gas, at the same temperature and pressure.

It is thus easy to deduce the percentage of argon present in these volumes and thereby adjust the injected quantities.

Possibly, to take into account the phenomena of sudden movements of liquefied gases made up of non-homogenous mixtures (roll over phenomenon due to the sudden rise and evaporation of liquid initially at the bottom of the tub), valve systems (28) may be installed in the suspended ceiling to prevent the latter from having to undergo the strong pressure difference variations between the volumes (26) and (27) that that type of incident can generate. These valves will normally be closed, and sealed relative to the argon trapped above the suspended ceiling (12), and will only open if necessary.

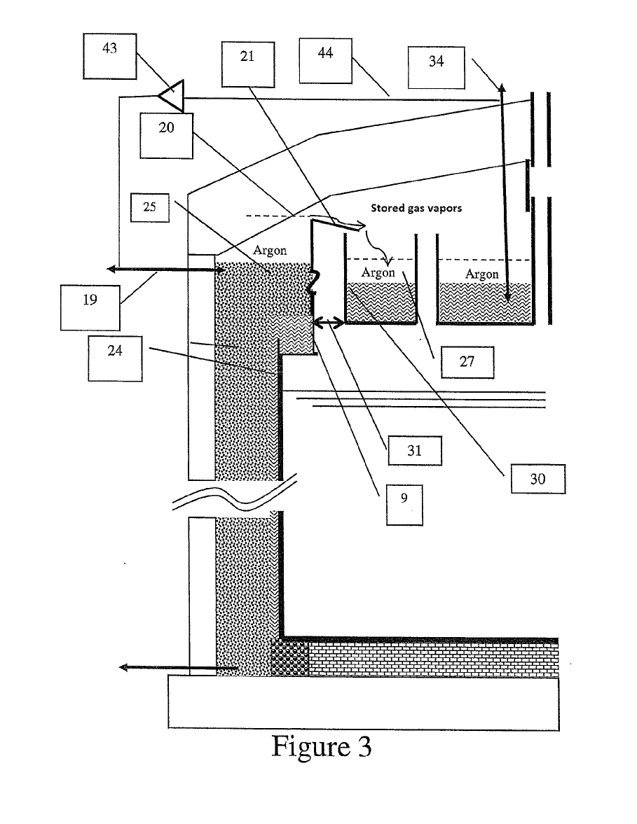

As an alternative to the installation of flexible and tight seals (3), it is possible to place, on the perimeter of the ceiling (12), as indicated in FIG. 3), a circular wall (30) sealably connected to the suspended ceiling (12). The argon present in the volume (27) will then be confined, by gravity, to the top of the ceiling (12). In that case, it may be possible to eliminate the valves (28) by arranging a gap (31) between the walls (30) and (9) sufficient to ensure that the pressure differences on either side of the ceiling (12) in case of roll over will remain within acceptable limits.

Alternatively, or as a complement to the valves (28), the ceiling (12) may be equipped with sealing pipes (32) emerging above the highest position of the border (22) between the argon and the vapors of the gas contained in the tub (1). In that way, in a normal regime, due to the effect of gravity, the argon cannot flow through those pipes, whereas, in case of roll over, the two volumes (26) and (27) will remain in communication, which will limit any pressure difference.

The walls (8), (9), (11) and the connection (10) being sealed to the argon, the volume (27) situated above the ceiling (12) may be supplied with argon from the volume (25) via the inclined or non-inclined pipes (21) that will cause the argon to flow by gravity from that volume (25) toward the volume (27) once the argon level (20) reaches their height, passing above the gap (31). It is therefore also advantageously possible to use the same argon source to supply the volumes (25) and (27).

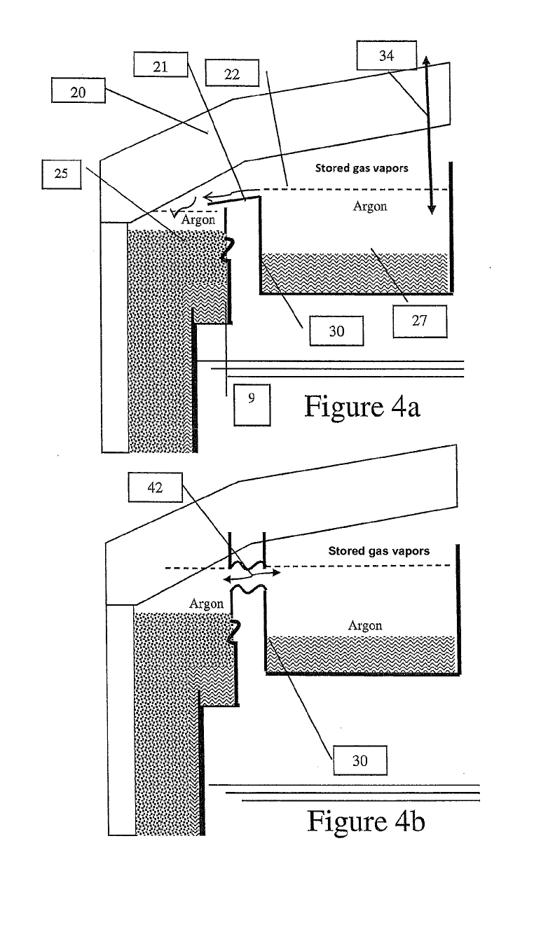

Alternatively, as illustrated in FIG. 4a, the volume (25) may advantageously be supplied from the volume (27) by orienting said pipes (21) in the other direction. In that case, the pipe (34) will supply the volume (27) with argon by passing through the roof (17).

It is also possible, as shown in FIG. 4b, to connect these two volumes by flexible and sealed pipes (42) that will make it possible to supply both volumes with argon at the same time, while also mechanically uncoupling the wall (30) from the walls (9) and (11). The pipes (19) or (34) may then indifferently supply the volume (25) or the volume (27), then by gravity, all of the insulating volumes (2), (5), (6) and (7) placed below.

Under certain conditions and with certain gases, for example certain varieties of natural gas that contain hydrocarbons heavier than argon, the vapors of these hydrocarbons can accumulate in the lower portion of the insulating volumes (5), (6) and (2), under the argon vapors. To avoid this, bleeds (29) and (33) may be installed in the lower portion of those volumes to prevent buildups of those gases, which may deteriorate the performance of the tank's insulation.

### 4. APPLICATIONS OF THE INVENTION

Consider (see FIGS. 1 and 2 a tub (1) with a height of 20 m, a diameter of 70 m and an insulating thickness of the walls of 60 cm.

The average temperature of the volume of the argon when the tub is full can be estimated at about 200 Kelvin whereas when the tub is empty, it can rise to about 300 Kelvin, close to ambient temperature.

At a constant pressure, the volume of argon contained in the insulating volumes (2), (5), (6) and (7) will therefore go from about 4500 to 7000 m³.

These additional 2500 m³ will therefore move by filling the volume (25), then will flow via the pipes (21) or (42) toward gaseous domes (27).

Likewise, the volume of the argon vapors trapped above the ceiling (1)(2) in the volume (14) will go from 2300 to about 3500 m³.

One therefore sees that the total expansion of the gaseous volume of argon will be in the vicinity of 3700 m3, which will generate an upward displacement of the border (22) of about 1 m, largely below the available height between the ceiling (12) and the roof (17), which is, at minimum, in the vicinity of 2 to 3 m.

Conversely, during filling of the tank that is initially empty, and close to room temperature, with liquefied gas, the argon present in the insulating spaces will gradually contract and it will be necessary to transfer the argon having accumulated there previously from the volume (27) toward the other insulating volumes. This may be done, by simple gravitational effect, by the pipes (42) or by a circuit (44) provided with a compressor (43) ensuring this decanting via the circuits (34) and (19) or (29).

This decanting compressor may also be used, in the other direction, to bring argon toward the gaseous dome (27) during heating of the insulating volumes.

Likewise, the pressure in the gaseous dome of the tank is not constant and can evolve in a range of several tens of mbar. These pressure variations will also cause variations in the volume of argon of several percent, which can be easily absorbed by the displacement, by several tens of centimeters, upward or downward, of the border (22) between the argon and the vapors of the gas contained in the tub (1), without having to store excess argon escaping from the insulating volumes outside the tank, the volume of argon trapped above the ceiling (12) serving as expansion volume.

This invention can be applied to new tanks, but also existing ones, on the condition of modifying the ceiling (12) to seal it to argon to prevent it from flowing by gravity into the gas ceiling (26).

Alternatively, if this operation is not possible (for example because it requires having access to the inside of the tank), one may apply the invention, partially, by only filling the volumes (2) or (5) and (6) with argon and leaving the volume (27) filled with the vapors of the gas stored in the tub (1). The reduction of the evaporation level will be smaller, but the cost of the operation will be greatly reduced, as it will be limited to the installation of the bleeds (19) and (29), or to the use of already-existing bleeds for other uses (for example, passage for instruments) and the provision of argon, the volume (25) serving as an expansion volume during temperature and pressure variations.

In terms of the safety of storage for potentially dangerous gases, such as LNG or liquid oxygen, it will be noted that the invention also has the advantage of filling the insulating spaces with a non-dangerous gas surrounding the storage tub with an inert gas space.

1. A double-walled liquefied gas tank, characterized in that one or more of the insulating spaces around the tub containing the liquid are filled with a mixture made up primarily of argon, trapped by gravity, between the outer walls of the tub and respectively:
a. for the insulating volume (2) situated under the bottom of the tub, the base (3) supporting the tub;
b. for the insulating volumes (5 and 6), the circular enclosure (16);
c. for the insulating volumes (7 and 25), the circular enclosure (16) and the roof (17);
d. for the insulating volume (14), the suspended and sealed ceiling (12).

2. The tanks according to claim 1, characterized in that they are equipped with one or more pipes (32), emerging above the border (22) between the argon trapped by gravity above the ceiling (12) and the vapors coming from the gas stored in the tub (1) and putting the gaseous domes (26) and (27) in communication.

3. The tanks according to claim 1, characterized in that the sealed and suspended ceiling (12) is equipped with one or more valves (28), normally closed and sealed to the argon gas, making it possible to limit, by opening, in case of incident, the pressure deviation between the gaseous dome (26 and 27) situated below and above said ceiling.

4. The tanks according to claim 1, characterized in that the quantity of argon present in the insulating spaces can be adjusted via one or more pipes (19, 29, 33, 34 or 37) respectively passing through the outer enclosure (16), the roof (17) or the base (3).

5. The tanks according to claim 1, characterized in that any heavy gas vapors trapped in the insulating volumes are discharged via one or more pipes (29 or 33) emerging in the lower portion of said volumes.

6. The tanks according to claim 1, characterized in that the suspended ceiling (12) is sealably connected to the gas by a flexible membrane (13) either at the vertical wall of the tub (1), or at the circular ring (8) or the barrier (9) so as to prevent the argon contained above the ceiling (12) from flowing, by gravity, into the gaseous dome (26).

7. The tanks according to claim 1, characterized in that the sealed ceiling (12) is equipped on the perimeter thereof with a sealing wall (30), higher than the border (22) between the argon vapors and the vapors of the stored gas, so as to prevent the argon contained above the ceiling (12) from flowing, by gravity, into the gaseous dome (26).

8. The tanks according to claim 7, characterized in that a gap (31) exists between the wall (30) and the walls (9 and 11) making it possible to maintain as small pressure difference between the volumes (26 and 27) placed on either side of the ceiling (12).

9. The tanks according to claim 1, characterized in that pipes (21) or flexible hoses (48) connect the insulating volume (25) and the gaseous dome (27).

10. The tanks according to claim 1, characterized in that a circuit (44) equipped with a compressor (43) makes it possible to ensure the decantation of argon between the volumes (6 or 25) and the dome (27) so as to use the latter volume as expansion volume for the argon vapor contained in the insulating volumes when they are heated or the pressure in the tank drops.

11. The tanks according to claim 1, characterized in that the concentration of argon in the different insulating spaces is monitored by measuring the hydrostatic pressure between the top and bottom of said volumes by measuring with the sensors (38, 39 or 41).

12. The tanks according to claim 1, characterized in that the outside discharge pipe for the vapors escaping the stored liquid (18) is equipped with a baffle or an equivalent system (23) preventing said vapors from driving the argon vapors present in the gaseous dome (27).
